(19) United States
(12) Patent Application Publication
(10) Pub. No.: US 2007/0166671 A1
(43) Pub. Date: Jul. 19, 2007

(54) Display device

(76) Inventor: Peter Walter, Lancaster, PA (US)

Correspondence Address: MCNEES, WALLACE & NURICK LLC, 100 PINE STREET, P.O. BOX 1166, HARRISBURG, PA, 17108-1166, US

(21) Appl. No.: 11/312,743

(22) Filed: Dec. 20, 2005

(51) Int. Cl. G09B 19/00

(52) U.S. Cl. 434/98

(57) ABSTRACT

A display device having a display portion having a screen for viewing a motion picture video. The display device also includes a processing device in communication with the display portion capable of converting motion picture video data to a motion picture video on the screen and audio data in the sound playback. The motion picture video simulates the view as seen from a window, having single point of view, real-time recordings of video locations having continuous motion picture video segments. The display device also includes framing attached to the display portion configured to provide the display portion and the framing with the appearance of a window, framed photograph, painting or wall-hanging.

### FIELD OF THE INVENTION

The present invention is directed to display devices capable of displaying motion picture videos simulating views that may be seen in a picture, painting or from a window.

### BACKGROUND OF THE INVENTION

Paintings, wall-hangings, framed photographs and windows provide displays that are pleasing to the eye. However, paintings, framed photographs and wall-hangings suffer from the drawback that they are fixed and do not change over time without physically removing and replacing the painting, photograph or wall-hanging. Windows provide aesthetically pleasing views, but suffer from the drawback that windows require to penetrate wall surface, special construction, provide a fixed point of view and allow heat and/or cold to more easily infiltrate the room.

Attempts at providing visually pleasing paintings has been attempted by providing movement to the paintings, through video. Websites, such as www.nomig.com, discuss ambient video, which includes cinematic aspects like transition, layering, superimposition, slow motion, split screen and other cinematic effects to provide the pleasing visual display. These ambient videos may be played in the background, but provide displays having cinematic effects configured for foreground attention. However, ambient paintings fail to simulate windows and do not provide views of different locations capturing real moments in time. In addition, the known ambient videos do not provide sound, such as surround sound, as a part of the background experience.

What is needed is a display device that provides the appearance of a painting, wall-hanging, framed photographs or window that is not limited to a single display or point of view and does not suffer from the drawbacks of the prior art.

### SUMMARY OF THE INVENTION

The display device according to the present invention offers customizable, controlled, visual and emotional experience helping to release stress and create desired state of mind. The display device provides a method and device capable of providing the appearance of an extension of a room space into an aesthetically pleasing location. In addition, the display device according to the present invention displays motion picture videos simulating views that may be seen in a painting, wall-hanging, framed photographs or from a window.

The present invention includes a display device having a display portion having a screen for viewing a motion picture video. The display device also includes a processing device in communication with the display portion capable of converting motion picture video data to a motion picture video on the screen. The motion picture video simulates the view as seen from a window, having single point of view, real-time recordings of video locations having continuous motion picture video segments. The display device also includes framing attached to the display portion configured to provide the display portion and the framing with the appearance of a window, painting, framed photograph or wall-hanging.

The present invention also includes a display device system having a video capture device, a computing device in communication with the video capture device and a display device. The display device includes a display device having a display portion having a screen for viewing a motion picture video. The display device also includes a processing device in communication with the display portion capable of converting motion picture video and audio data from the video and audio capture device to a motion picture video on the screen and audio in sound system. The motion picture video simulates the view as seen from a window, having single point of view, real-time recordings of video locations having continuous motion picture video segments. The display device also includes framing attached to the display portion configured to provide the display portion and the framing with the appearance of a window, painting, farmed photograph or wall-hanging.

The present invention also includes a method for visually extending a room space and creating desired controlled emotional experience. The method according to the present invention includes capturing motion picture video data with a video and audio capture device. The motion picture video data is processed to produce a motion picture video. The motion picture video is displayed on a display device. The display device includes a display portion having a screen for viewing the motion picture video. The display device also includes a processing device in communication with the display portion. Framing is attached to the display portion and is configured to provide the display portion and the framing with the appearance of a window or wall-hanging. The motion picture video simulates a view as seen from a window, having single point of view, real-time recordings of video locations having continuous motion picture video segments.

The display device according to the present invention may be provided for use in residential buildings wherein various advantages may be provided to different locations within the building. One advantage for locations, such as residential basements, includes the addition of natural-like light to the space having few or no windows. This additional light may extend the living space and value of the house. Other advantages to rooms, such as dining rooms, may include controlled, exotic, and/or ambient surroundings for dining with the ability to select desired location and time for each occasion hosted in the room space.

The display device according to the present invention may also be provided for use in hospitality resorts, such as hotels, spas, health clubs, bars, and/or restaurants. Advantages for locations, such as lobbies and waiting areas, includes a controlled, unique branding, ambient surrounding for guest and customers with the ability to modify experience for specific occasions. Advantages for locations, such as hotel rooms, includes the creation of a relaxing atmosphere with customizable visual and emotional experience to release stress and suit the actual moods of the guests. Advantages for locations, such as lounges, bars, and restaurants, includes the creation of a unique, themed ambient surrounding (experience) to go with the type of location style, played music, served food & drinks with additional ability to further customize experience for specific occasions.

The display device according to the present invention may also be provided for use in corporate spaces, such as headquarters, office buildings, convention centers. Advantages for locations, such as offices and meeting rooms, include increases in productivity and efficiency by generating positive, creative atmosphere in working environment. Advantages for locations, such as receptions and waiting spaces, include reinforcing desired brand impression by providing controlled visual and emotional experience with ambient video and synchronized background sound.

The display device according to the present invention may also be provided for use in retail environment, such as shopping centers, and department stores. Advantages for locations, such as boutiques, and fashion shops, include support of a positive shopping experience by providing interesting emotional background leveraging ambient video and synchronized background music for the customers.

The display device according to the present invention may also be provided for use in offices such as, offices of dentists, lawyers, and doctors. Advantages for locations, such as reception, and waiting spaces, include pleasant atmospheres that may release stress and/or anxiety and encourage optimistic feelings by creating relaxing atmosphere with customizable visual and emotional experience. Advantages for locations, such as offices, and meeting rooms, include increased productivity and efficiency by generating positive, creative atmosphere in working environment.

The display device according to the present invention may also be provided for use in healthcare and senior living locations. Advantages for locations, such as receptions, and waiting spaces, include encouragement of well-being by creating relaxing atmosphere with controlled visual and emotional experience.

The display device according to the present invention may also be provided for use in healthcare and transportation related locations. Advantages for locations, such as waiting lounges, include making waiting time a more relaxing experience and releases stress by providing controlled visual and emotional experience with ambient video and sound. Advantages for locations, such as checking and ticketing areas, include pleasant atmospheres that may release stress and encourage optimistic feelings for reinforcing desired brand impression by providing controlled visual and emotional experience.

The display device may be easily installed in a variety of locations. The operation of the display device is simple and requires little or no interaction with a user.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows a display device according to an embodiment of the present invention.

FIG. 2 shows a method of room space extension experience according to an embodiment of the present invention.

FIG. 3 shows a display device system according to an embodiment of the present invention.

FIG. 4 shows a method step according to an embodiment of the present invention.

FIG. 5 shows another method step according to an embodiment of the present invention.

FIG. 6 shows still another method step according to an embodiment of the present invention.

FIG. 7 shows a display device system according to an embodiment of the present invention.

FIG. 8 shows a display device according to an embodiment of the invention installed within a room space.

FIG. 9 shows a cutaway side view of the installation of a display device according to the present invention.

FIG. 10 shows a display device according to another embodiment of the invention installed within a room space.

FIG. 11 shows a display device according to still another embodiment of the invention installed within a room space.

FIG. 12 shows a display device according to still another embodiment of the invention installed within a room space.

FIG. 13 shows a display device according to still another embodiment of the invention installed within a room space.

FIG. 14 shows a display device according to still another embodiment of the invention installed within a room space.

FIG. 15 shows an arrangement of display devices according to still another embodiment of the invention installed within a room space.

Wherever possible, the same reference numbers will be used throughout the drawings to refer to the same or like parts.

### DETAILED DESCRIPTION OF THE INVENTION

The present invention includes a display device for displaying motion picture video and playing audio that is configured to simulate a window, wall-hanging, framed photograph or painting. Paintings, framed photograph and wall-hangings are defined as any painted, printed photographed or otherwise recorded image, preferably an image mounted on a wall with or without a frame, wherein the image displayed is a landscape, cityscape or other panoramic view or sport, music and similar event. Motion picture video is defined as video and audio, digitized motion pictures, moving images, or other data format and the data making up the video, digitized motion pictures, moving images, providing displayed images of sufficient resolution to simulate a window, wall-hanging, framed photograph or painting and audio, sound of the location or synchronized background music. Windows, as defined herein, are not limited to glass containing openings in walls, and may include full openings in walls, doors, open doorways or any portal or device through which a view may be seen by an observer. Moreover, a portal or device may include any viewable surface of any object on or in a structure, such as a backing of a chair, file cabinet, furniture, or self supporting picture frame that is stationary when placed, but is capable of being moved to a different location. Additionally, the wall of a structure includes any portion of a floor or ceiling of a structure. Also, structures may be non-planar and have rounded or angled surfaces.

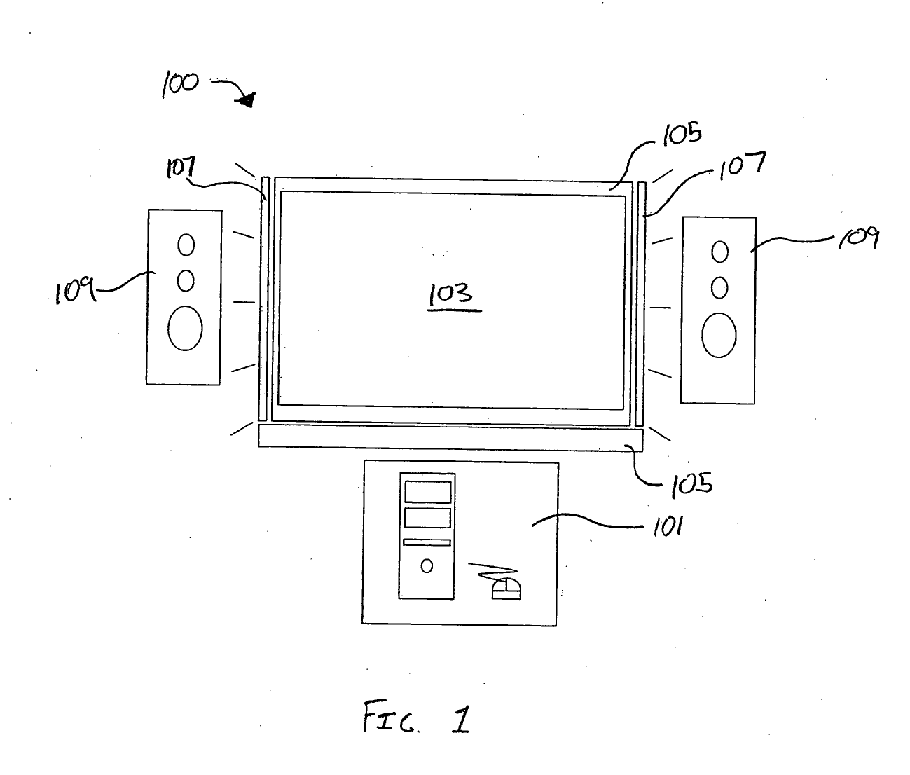

FIG. 1 shows a display device 100 according to the present invention. Display device 100 includes a processing device 101, such as a microprocessor or similar data processing device, connected to a display portion 103. Processing device 101 is configured to process motion picture video and audio data and provide an output that may be used by the display portion 103 to display the motion picture video. The processing device 101 stores, reads or receives the motion picture video and audio, if necessary, processing the data, and transmits the data to the display portion 103 in order to display the motion picture video and to the audio output to play sound. Although the processing device 101 is shown as a separate component, the processing device may be incorporated into the display portion 103, the framing 105 or other feature of the display device 100. The processing device 101 is preferably mounted in such a way so as to hide the processing device 101 from view. Display portion 103 is preferably a flat screen of a standard, high or custom resolution monitor or television. The display portion 103 is preferably sufficiently flat, when mounted, to provide the appearance of being incorporated into the wall as a window or only extending away from the wall the same distance as a painting, framed photograph or wall-hanging. However, it is to be understood that the display portion 103 can be configured to conform to the contour of the wall of a structure onto which the display portion 103 is mounted, such as a curved surface. Framing 105 may be provided to facilitate the simulation of the window, door, wall-hanging, framed photograph or painting. Framing 105 may be in any suitable configuration including, sills, picture frames, ornamentation, or any configuration that provides an appearance of a window, door, wall-hanging, framed photograph or painting. Framing 105 is preferably adjacent to the display portion 103 and may be attached, covering or built into the display portion 103. The framing 105 may also form a hinged access to the rear of the display portion for maintenance or repair.

Display device 100 may also include a lighting device 107 to provide a space with appropriate lighting to a particular location viewed. The lighting provided by the lighting device 107 may be controlled for brightness, color and/or intensity. For example, a sunny location, such as a sunny beach location, may require addition lighting beyond the lighting present in a room. Likewise, darker sunset viewings, or locations at night may require less lighting, special color lighting or even no lighting. Display device 100 may also include a sound-producing device 109, such as audio speakers or other device capable of producing sound. Sound, preferably recorded sound from the location viewed in motion picture video or synchronized background music, may be provided to the room in which the display device is installed. The sound may be configured as a surround sound or other realistic sound providing system. Sounds provided by the sound-providing device 109 preferably are ambient. Ambient as defined herein is a sound, lighting or visual display that substantially blends into the surroundings, and does not draw undue attention when present in a room space. For example, in a motion picture video of a cityscape, unedited recorded sound from the city street location recorded as motion picture video is sufficient to provide the ambient sound. Control for the lighting device 107 and the sound-producing device 109 is provided by the processing device 101 and is preferably associated with the motion picture video being displayed by the display portion 103.

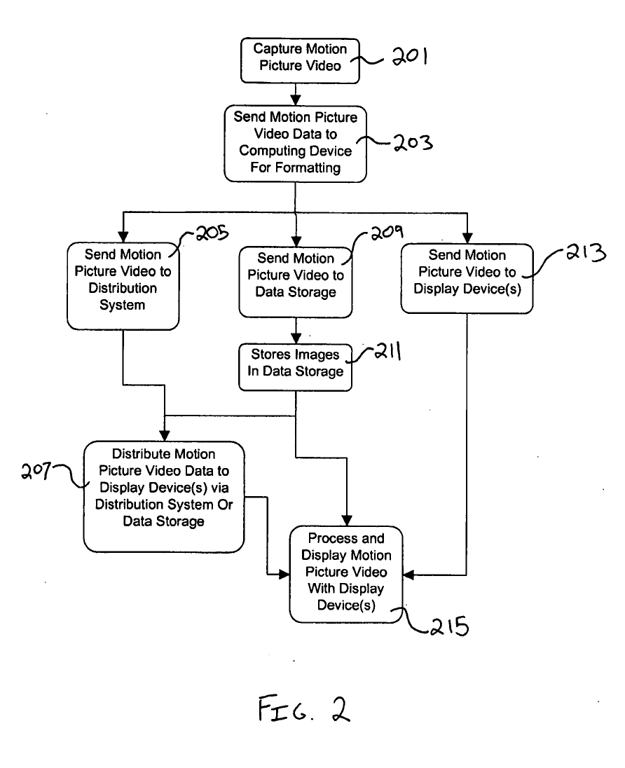

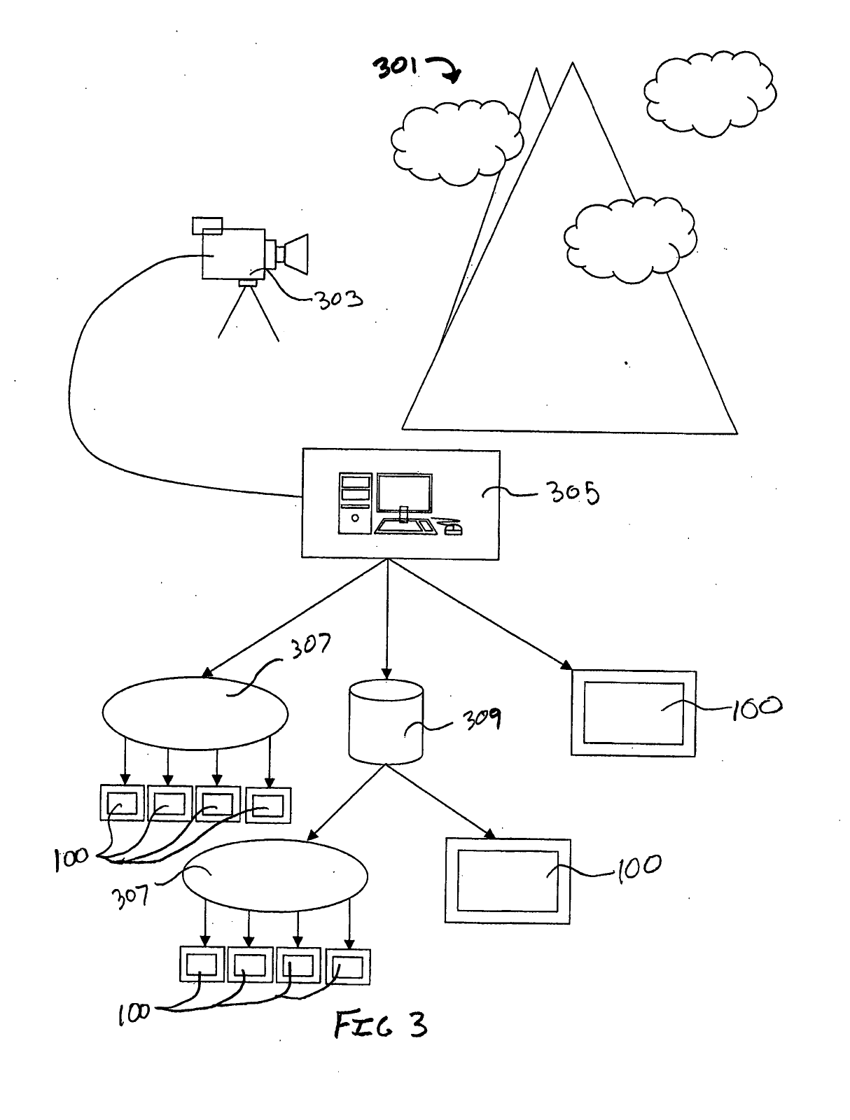

FIG. 2 shows a process according to the present invention for providing motion picture video to the display device 100. A video location 301 (see FIG. 3) is selected and a motion picture video and audio of the video location 301 is captured in step 201 by a video and audio capture device 303. Devices that are suitable as video and audio capture devices 303 include video-camera, camcorder, digital camera or other device capable of capturing a motion picture video and audio. The captured motion picture video and audio is transferred to a processing or computing device 305, such as a microprocessor, in step 203. The computing device 305 formats the data from the video and audio capture device 303 into a form that may be transferred to distribution, data storage or to the display device 100 and can add any additional information, such as subject name and location, location description, date and time and any other identifying information desired. In addition, the processing device or computing 305 may encode the data for streaming over a transfer medium, such as the Internet, satellite, cable, terrestrial digital or conventional TV. Editing by the computing device 305 is limited and includes formatting, adding identifier data, modifications to playback speed and minor image improvement. Editing by the computing device 305 does not include combining multiple camera views and/or cuts between camera views or any attention attracting digital effects.

Once the data has been processed by the computing device 305 in step 203, the motion picture video and audio, which has been appropriately formatted, is sent to at least one of a distribution system 307 (see FIG. 3), a data storage 309 (see FIG. 3) or the display device 100. In one embodiment, the motion picture video and audio, in the form of data, is sent to the distribution system 307 at step 205. The motion picture video and audio is then distributed by the distribution system 307 to the display device 100 in step 207. In another embodiment shown in FIG. 2, the motion picture video and audio from the computing device 305 is sent to data storage in step 209, wherein the motion picture video and audio data is stored in step 211. The stored data in step 211 may be transferred to the display device 100 or may be transferred to the distribution system in step 207 prior to being transferred to the display device 100. In still another embodiment of the present invention shown in FIG. 2, the motion picture video and audio from the computing device 305 may be sent directly to the display device 100 via step 213. Regardless of whether the data is received from the process via step 213, the data storage 309 via step 211 or the distribution system 307 via step 207, the display device 100 processes the motion picture video and audio data in step 215 and displays the motion picture video and plays audio in step 215.

FIG. 3 shows a schematic view of the motion picture video and audio acquisition and distribution system according to the present invention. A suitable video location 301 is recorded with a video and audio capture device 303. The video and audio capture device 303 is any device capable of recording the motion picture video and audio and may include, but is not limited to, a video-camera, camcorder, digital camera or other device capable of capturing a motion picture video and audio. The video and audio capture device 303 transfers the motion picture video and audio data to a computing device 305. The computing device 305 formats the data and transfers the data to one of a distribution system 307, data storage 309 or one or more display devices 100. As shown on the left branch below the computing device 305 in FIG. 3, if the motion picture video and audio data is sent to the distribution system 307, the data is appropriately formatted and distributed to a plurality of display devices 100. As illustrated in the center branch below the computing device 305 in FIG. 3, the motion picture video and audio data may be sent to data storage 309, for retention of the motion picture video and audio data. Data storage 309 is any suitable data storage device, including but not limited to, optical memory, tape memory, hard or floppy disk, memory card or any other suitable data storage medium. Data storage 309 may be utilized as a library in which particular locations captured as motion picture videos may be organized, allowing browsing of the selections and downloading upon request. From data storage 309, the data may be transferred to a distribution system 307 for formatting and distribution to a plurality of display devices 100. The motion picture data may also be transferred to one or more display devices 100 for display of the motion picture video and play audio. In addition to the above embodiments, the computing device 305 may also transfer the motion picture video and audio data directly to the display device 100 for processing and display, as shown in the right branch below the computing device 305 in FIG. 3. The display device 100 receives, processes, displays and plays the motion picture video and audio data.

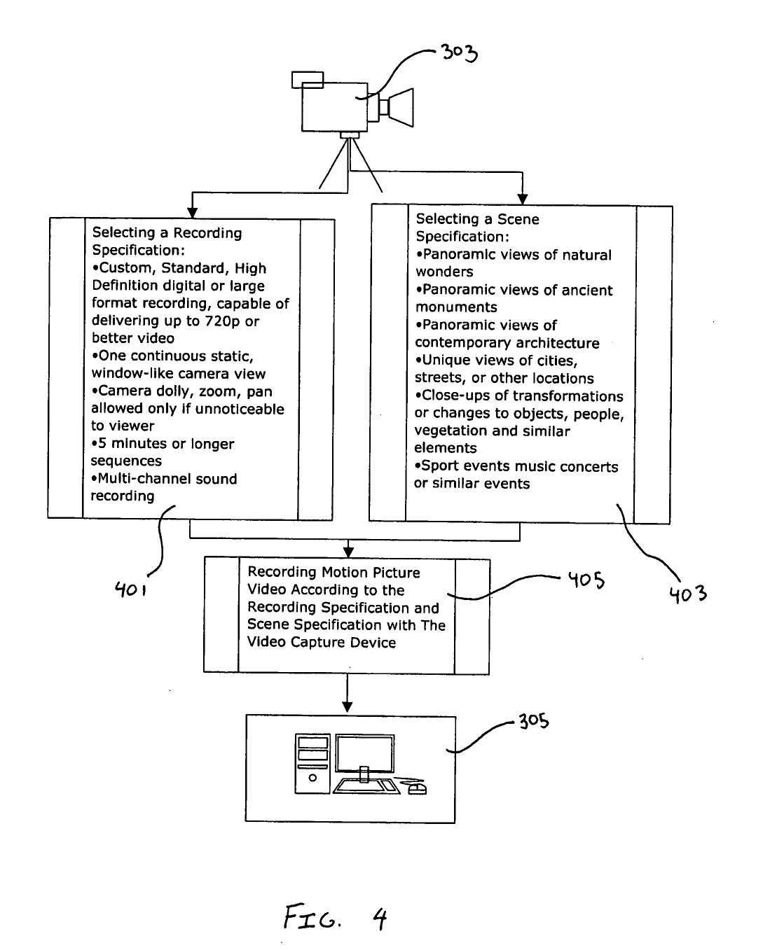

FIG. 4 shows a method of capturing motion picture video and audio according to an embodiment of the present invention, corresponding to step 201 in FIG. 2. The video and audio capture device 303 is provided with the ability to record video and audio with specifications selected by the user. The specifications are selected in order to provide motion picture videos and audio that provide simulations of a window, wall-hanging, framed photograph or painting when viewed with a display device 100. Specifications for the motion picture video and audio are selected in step 401. Step 401, shown in FIG. 4, provides examples of specifications required for the motion picture video according to the present invention. The specifications may include standard definition with 525 NTSC, 625 PAL, 480 lines, high definition, with 720 lines of definition or greater or custom definition 120:160, 320:240, 640:480 and similar. The recording specification may also include a continuous, single camera view, with a single point of view to simulate a window. The motion picture video preferably includes no noticeable camera movement. The segments of motion picture video and audio provide a recorded length of time that exceeds about 5 minutes, preferably greater than 60 minutes. In one embodiment of the invention, the recording is 24 hours in length to record an entire calendar day at a given location. In addition to the visual display of the motion picture video, sound may also be recorded in a multi-channel format, preferably in a format that provides surround sound. In addition to the specifications, the motion picture video according to the present invention should include selection of the location. The location is selected in step 403 and may include, but are not limited to, panoramic views of natural wonders, panoramic views of ancient monuments, panoramic views of contemporary architecture, views of natural transformations, cityscapes or other ambient views and sporting, musical or other events. Once a location is selected for the motion picture video, the video and audio capture device 303 is activated to record the motion picture video of the location according to the specifications selected.

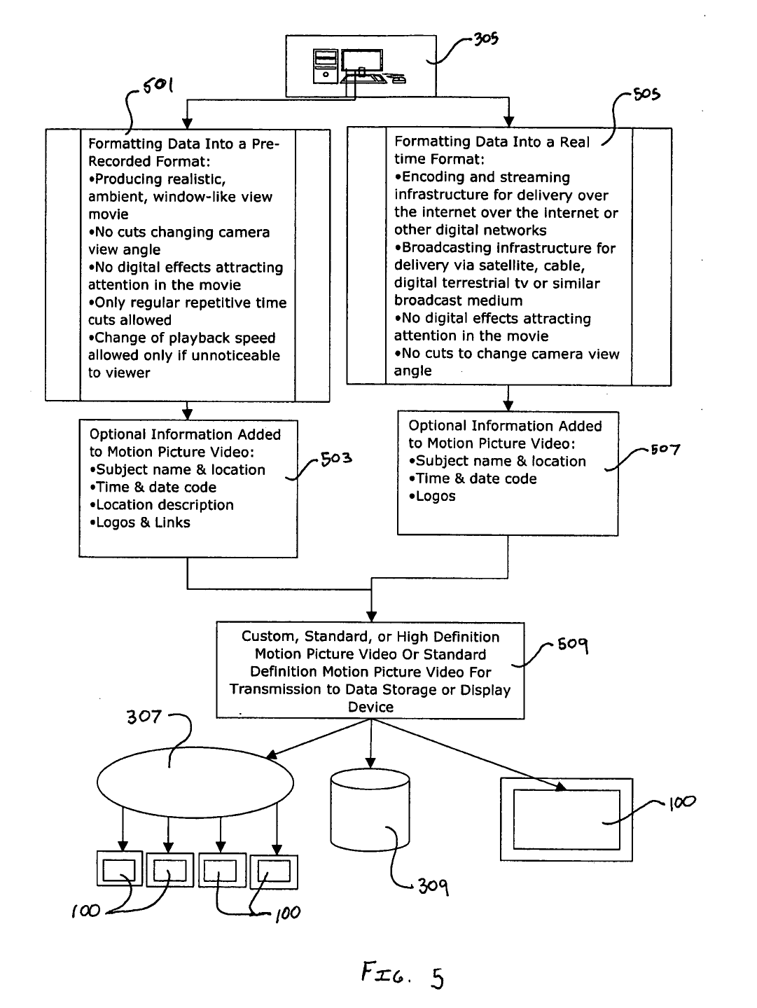

FIG. 5 shows a method of processing the motion picture video and audio in the computing device 305 according to an embodiment of the present invention, which corresponds to step 203 in FIG. 2. Data is formatted by the computing device 305 prior to transfer to the distribution system 307, data storage 309 or one or more display devices 100. The method shown in FIG. 5 includes formatting to either a recorded version or a real-time version. In step 501, the computing device 305 formats the motion picture video for storage in a pre-recorded format. As shown in FIG. 5, the format preferably includes producing formatted data corresponding to motion picture video that is realistic, ambient, window-like view movies, with no disruptive attention attracting digital effects, no cuts changing camera views, only regular repetitive time cuts are allowed, change of playback speed is allowed and a change of camera position (pan, zoom, dolly) is allowed if unnoticeable to viewer. Formatting provides compliance with the criterion, such as the criterion set forth in step 501. Once formatting to the pre-recorded format is complete, an optional step 503 is performed, wherein data, such as the location video 301 subject name and location, time and date and/or location description and/or other identifiers may be added to the motion picture video data, such as logos or links. FIG. 5 also includes formatting by the computing device 305 in step 505 to a real-time format, which is encoded for streaming over a broadcast medium, such as the Internet, satellite, cable, digital or conventional terrestrial TV or other method of broadcasting data to the display device. Once formatting to the real-time format is complete, an optional step 507 is performed, wherein data, such as the subject name and location of location video 301, time and date and/or location description and/or other identifiers, such as logos, may be added to the motion picture video data. Upon completion of the formatting steps, the data is transferred in step 509 to a distribution system 307, a data storage 309 or to one or more display devices 100.

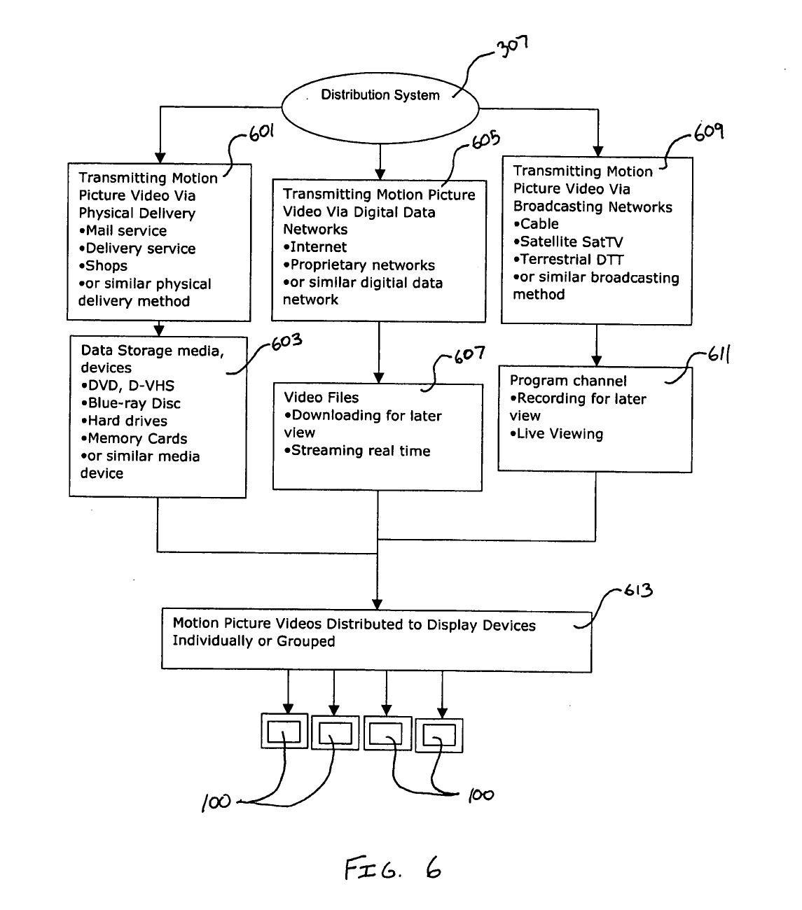

FIG. 6 shows the method of distributing the motion picture video via the distribution system according to an embodiment of the present invention, which corresponds to step 207 in FIG. 2. The distribution system 307 receives motion picture video and audio data from the computing device 305 or data storage 309 and prepares the data for distribution via physical delivery, digital data network or broadcasting network. In step 601, the motion picture video and audio data is prepared for a mail service, delivery service or for purchase in a store. The preparation of the data for physical delivery takes place in step 603 and may include formatting and storing the data on a storage medium, such as a DVD, D-VHS, blu-ray disc, hard drive, CD-ROM, memory card medium or other portable suitable storage medium for eventual download to the display device 100 by the consumer. Alternatively, the motion picture video and audio data may be transferred via a digital data network in step 605, such as the Internet, proprietary network, or other suitable digital data transmission network. The data transmitted in step 605 may include video and audio files that may be downloaded to the display device 100 for later viewing or may be streamed to the display device 100 for immediate viewing, in step 607. In a third distribution channel, the distribution method of the present invention may transfer the motion picture video data via a broadcast network, such as satellite, cable, digital or regular terrestrial TV or other method of broadcasting data to the display device, in step 609. The motion picture video and audio data may be provided to the display device 100 in a program channel format as a recording for later viewing or live viewing in step 611. Once the data is distributed, either by physical deliver, digital data network or by broadcast network, the data is transmitted or downloaded to the display device(s) 100 in step 613.

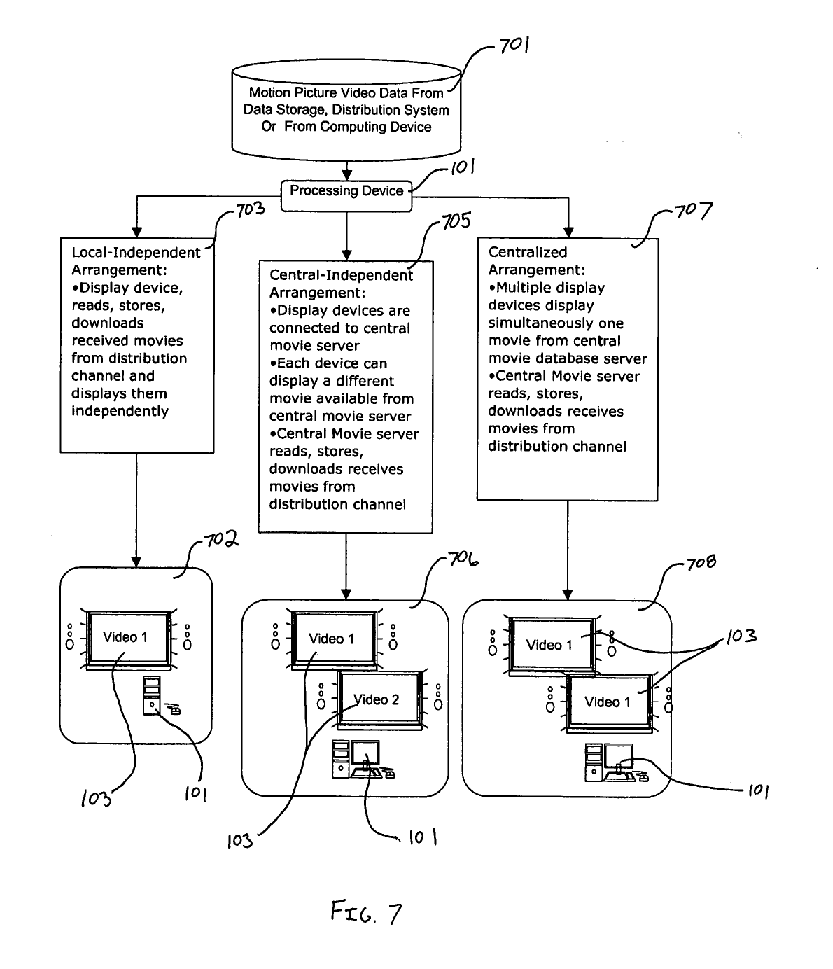

FIG. 7 shows the method of displaying the motion picture video by the display device 100, corresponding to step 215, as shown in FIG. 2. The motion picture video and audio data is transferred to the processing device 101 of the display device 100 in step 701. The processing device 101 is preferably a microprocessor capable of receiving motion picture data, either by data stream, memory media or by broadcast method, and transmitting the motion picture video and audio to the display portion 103 in a format displayable by the display portion 103. The processing device 101 is capable of encoding and playing a video signal in desired definitions and quality from the motion picture video and sound data. In addition, the processing device 101 may include ability for data storage and/or data retrieval/update for providing the display portion 103 with the pre-recorded or real-time motion pictures and sound of the video locations 301. The processing device 101 also includes means for updating or retrieving additional motion pictures for display on the display portion 103. In one embodiment of the invention, a data stream containing real-time motion pictures, via an internet feed, satellite connection, cable or the like, is provided to the processing device 101 and displayed in real-time. Features of the processing device 101 may include playing, pausing, loop playing, rewinding, fast forwarding, time-compression, timer function, motion detector start and switching locations may be included as functions of the processing device 101. The processing device 101 transmits the video signal to the display portion 103 for viewing and audio signal to integrated or external sound system for listening. Preferable display portions 103 include a flat-screen standard, high-definition or custom definition LCD/Plasma screen or other display technology. The display device 100 may also include sound, which is included as a portion of the motion picture video data and is processed by the processing device 101. The processing device 101, in addition to the video signal, sends a signal to the sound producing devices 109 in order to provide the desired sound. Desired sounds that are provided may include, for example, ambient sound from the location featured in the real-time motion images or synchronized background music. In addition to video and sound, lighting may also be provided. In order to provide appropriate lighting, the processing device may analyze the motion picture data or video stream and determine a desired intensity and/or color of lighting. The processing device 101 transmits a signal to lighting devices 107, which are adjusted to provide the desired intensity and color of lighting. Alternatively, the intensity and/or color of the lighting may be provided manually or by pre-recorded program. In one embodiment of the present invention, the processing device is a computer having a processor of 1.0 GHz or better, a memory 512 MB or more, hard drive: 1 GB, 7200 rpm or better, an optical drive/Removable media including DVD-ROM, CD+ROM or other similar device, Fire Wire 400, USB 2.0, USB 1.1, VGA output ports, an integrated 16-bit stereo, a high definition TV card, a 3D graphic card, an integrated 10/100/1000 LAN, BASE-T or similar network communication, an integrated Wi-Fi (802.11 g)3, Bluetooth 2.0+EDR or similar, and appropriate operating software. A primary function of the processing device 101 is as a media player in order to play standard, high and custom definition video and multiple channel sound, network communication for updates and maintenance, data storage, and display mode control (e.g., active, screen saver, sleep). The processing device may have secondary functions, such as reading removable media DVD, DVD-R, CD, CD-R, memory cards or similar, controls for connectivity via USB, FireWire, decodes HDTV signal or similar, operation peripheral components (e.g., keyboard, mouse, touch screen, etc. . . . ), controlling ambient lighting sources or, other functions, as needed, to deliver desired motion picture video experience.

FIG. 7 shows alternative display methods from the processing device 101. The processing device 101 may be used for an individual display device 100 or may be provided for multiple devices, either independently or simultaneously. In step 703, a processing device 101 provides the video signal to a single independent video portion 103. The display device in step 703 reads, stores, and/or downloads received movies from a distribution channel and displays them independently. As shown in step 702, a single video provided by the processing device 101 is displayed on the display portion 103. This embodiment provides flexibility in the operation of the display device 100, allowing the display portion 103 to provide any motion picture video available to the processing device.

In step 705, the processing device 101 is utilized as a central processor for multiple display portions 103. Display portions 103 are connected to central processing device 101, wherein each device can display a different movie available from a central movie server. The central movie storage server reads, stores, downloads and receives movies from a distribution or data channel. As shown in step 706, multiple independent videos and audios (i.e., “Video 1” and “Video 2”) are provided by the processing device 101 and are displayed on the multiple display portions 103 and can be played on multiple sound systems. The motion picture videos shown on each of the display portions 103 may independently be controlled. This embodiment provides flexibility in the operation of the display device 100, allowing the display portion 103 and sound producing devices 109 to provide any motion picture video available to the processing device 101, while reducing the cost per unit by eliminating the need to have a processing device for each display portion 103 or sound producing devices 109.

In step 707, the processing device 101 is also utilized as a central processor for multiple display portions 103. However, in the embodiment including step 707, display portions 103 are connected to central processing device 101 in order to show the same motion picture video. Multiple display devices 100 may display simultaneously one movie from data storage 309 and read, store, and/or download movies from the distribution or data channel. As shown in step 708, a single video and audio (i.e., “Video 1”) may be provided by the processing device 101 to multiple display portions 103 and to one or multiple sound producing devices 109. This embodiment provides a less expensive option, allowing a lower cost per display portion 103 by eliminating the need to having a processing portion for each display portion 103 and eliminating the need to provide multiple independent video and audio signals.

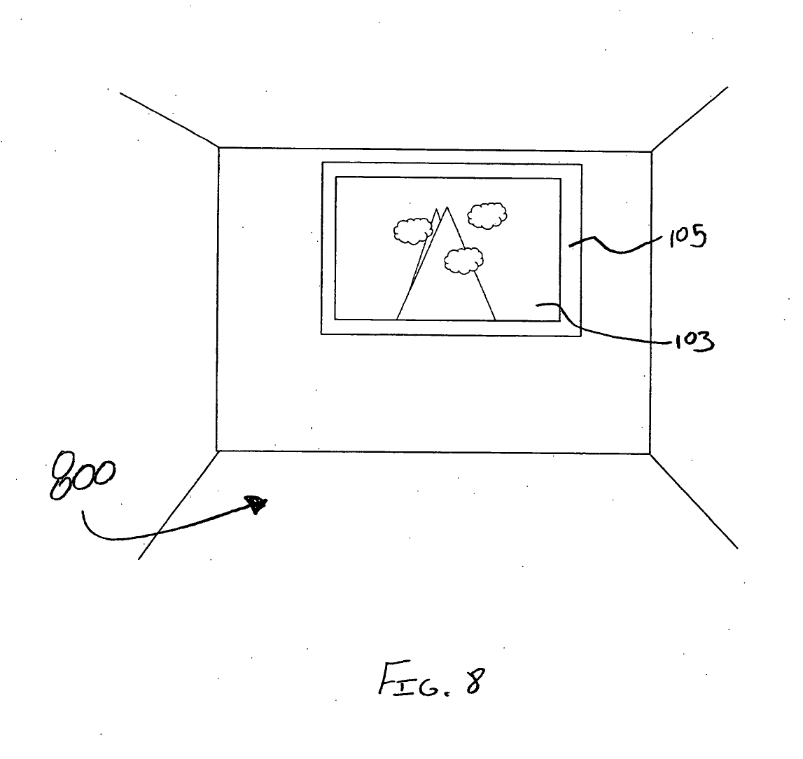

FIG. 8 shows an application of the display device 100 according to the present invention installed in a room space 800. The display device 100 includes framing 105 and a display portion 103. The display portion 103 displays the motion picture video. Processing device 101 is not shown and is either integrated into the display portion 103 or is hidden from view. Alternatively, wires or cables for a remotely located processing device 101 may be provided in order to facilitate the minimized viewing of the processing device 101. Although not present in FIG. 8, the display device 100 of the present invention may include lighting devices 107 and sound producing devices 109. Framing 105 preferably is fabricated from a material that simulates a window framing, photograph frame or a painting frame. Suitable materials for framing 105, include, but are not limited to wood, composites, plastic, metal or painted surfaces. Framing 105 may also include an integrated motion sensor in order to provide power saving or enhanced viewing. Framing 105 also provides addition space to accommodate the processing device 101, sound producing device 109, associated cables and other components of display device 100. Framing 105 also may allow easy access for cables and connections setup and device maintenance.

The display portion 103 may include a flat-screen monitor, tv or similar capable of displaying standard high custom definition/ resolution, video, such as LCD, plasma or similar flat screen display technology. One embodiment of the invention includes standard definition monitor/tv 525 NTSC, 625 PAL, 480 and similar. This embodiment further includes screen ratios of widescreen 16:9, conventional 4:3 or custom screen ratios. The brightness of the monitor is preferably 200 cd/m or better and the contrast ratio is preferably 250:1 or better. The size of the display portion 103 may be any size that simulates windows, framed photograph, wall-hangings or paintings.

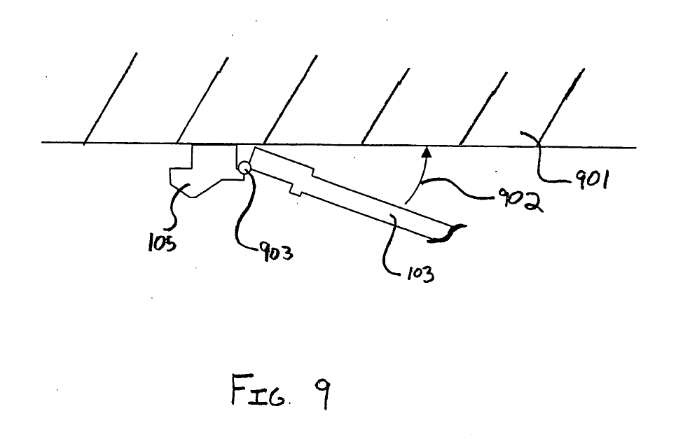

FIG. 9 includes a cutaway side view of the display device 100 according to the present invention. FIG. 9 illustrates the installation of the display device 100 in which framing 105 is mounted to a wall 901. Display portion 103 is hingedly engaged with the framing 105 and is rotated in direction 902 adjacent to the wall 901. A latching or other mechanism (not shown in FIG. 9) may be utilized at the distal end of the display portion 103 in order to retain the display portion 103 within the framing 105. A hinge 903 may also be installed to rotatabably connect the display portion 103 with the framing 105. Optional hinge 903 permits the display portion 103 to be rotated outward to provide access to the processing device 101, cables, connections or other wiring.

Applications for the display device 100 may include methods of display simulating a window in a windowless office, waiting areas, or lobbies, or hotel rooms and apartments with blocked or unpleasant natural views wherein the view from the digital window may be a remote, or visually pleasing location. The display devices 100 may also provide time-shifting or season-shifting, providing a space with a simulated window to a season or a time or an event that has already past. For example, during cloudy or rainy days, pictures of pleasant, sunny locations and/or weather may be provided on a simulated window or display piece. Gallery displays, including multiple display devices 100 showing a variety of video locations 301 in uninterrupted pre-recorded or real-time for display purposes.

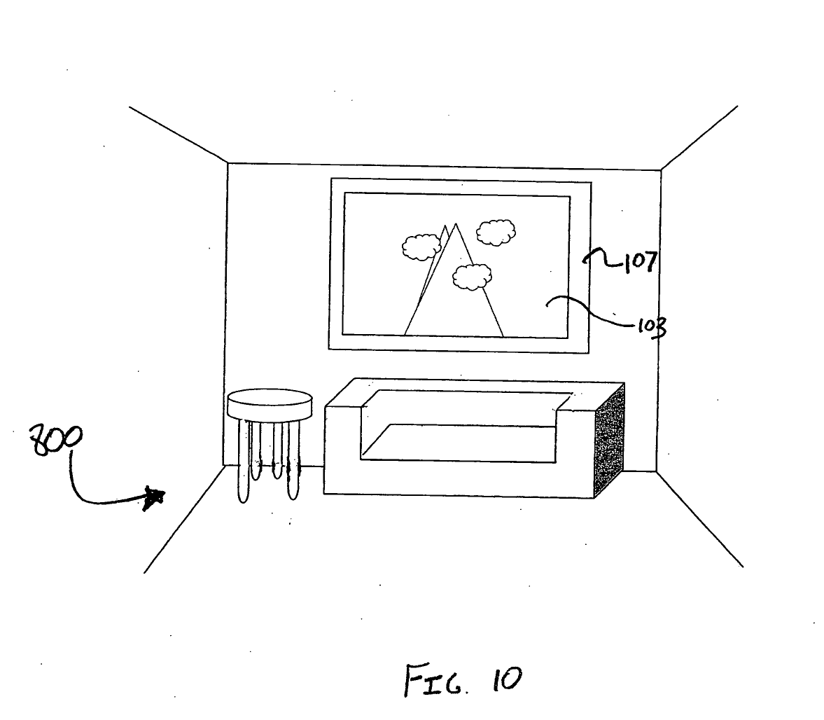

FIG. 10 shows one embodiment according to the present invention including a display device 100 mounted in a residential or commercial room space 800. The display device provides advantages for locations, such as windowless or blocked view rooms or basements, including the addition of natural like light to the room space 800. This additional light may extend the usable space and value of the building. Other advantages may include controlled, exotic, and/or ambient surrounding for dining or entertaining with the ability to select desired location and time for each occasion hosted in the room space.

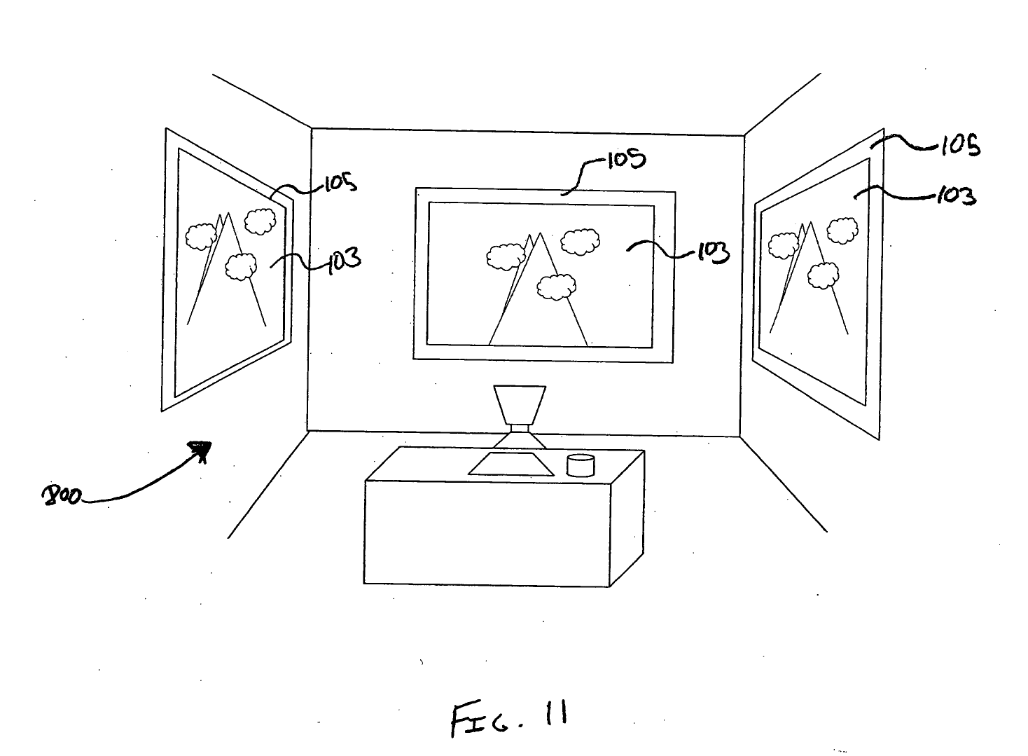

FIG. 11 shows one embodiment according to the present invention including a display or blocked view device 100 mounted in an office room space 800. Advantages for locations, such as offices, and meeting rooms, include increased productivity and efficiency by generating positive, creative atmosphere in working environment. The embodiment shown in FIG. 11 further includes the installation of multiple display devices 100, which provide a surrounding view, providing the ability to transform a windowless office into a corner office, with a view in three directions. The multiple display devices 100 may be independent of each other or may provide the same motion picture video or may provide independent but synchronized views/motion picture videos of the same location.

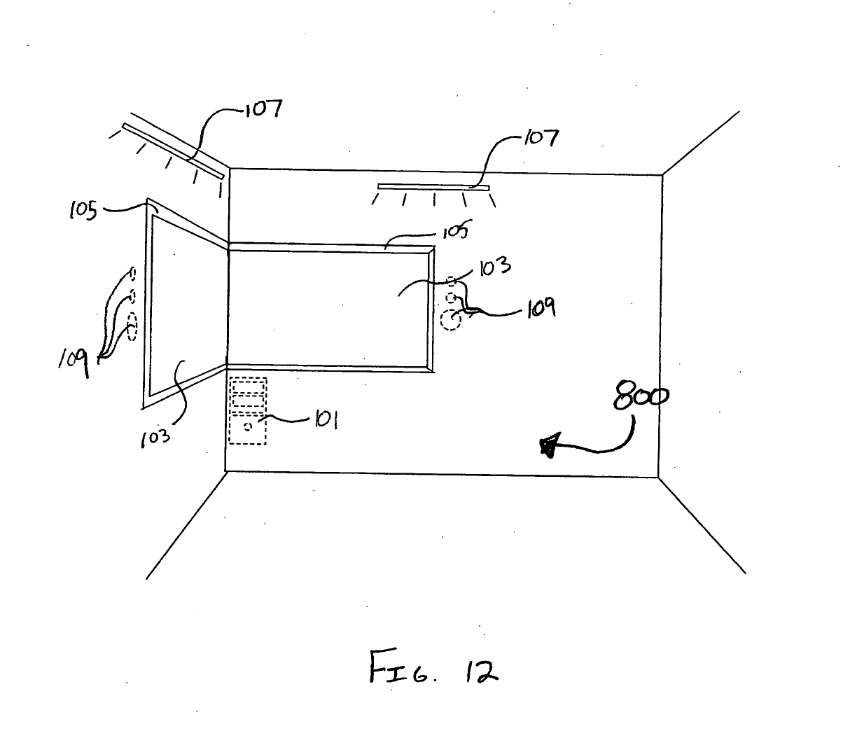

FIG. 12 shows another embodiment according to the present invention including a display device 100 mounted in a comer space. In the embodiment shown in FIG. 12, the display device 100 includes lighting devices 107 and sound producing devices 109 (shown in broken lines). In addition, FIG. 12 shows the processing device 101 mounted below the display portion 103 and framing 105. The processing device is preferably hidden from view. Although FIG. 12 shows the processing device 101 mounted below the display portion 103 and framing 105, the processing device 101 may be mounted in any suitable location and is preferably disposed in a location hidden from view. In one embodiment of the present invention, the processing device is disposed in a location hidden by framing 105.

Lighting devices 107 provide appropriate lighting to the room space 800. The lighting devices may provide lighting that is direct or indirect. In addition, color and light intensity of the lighting may be controlled by processing device 101. In addition, the lighting devices 107 may be manually configured and/or a predetermined program may provide appropriate lighting. In the event that the processing device 101 provides the control of the lighting device 107, the intensity and the color of the lighting may be synchronized with the movie displayed on display portion 103.

Sound producing devices 109 are devices, such as audio speakers amplifier or other device capable of producing sound. Sound, preferably recorded sound from the location viewed in motion picture video or synchronized background music, may be provided to the room space 800 in which the display device is installed. The sound may be configured as a surround sound or other realistic sound providing system. Sounds provided by the sound providing device 109 are preferably location ambient noise or location style corresponding syncronyzed background music. The sound producing devices 109 are preferably hidden from view and may be incorporated into the framing 105. The sound producing devices 109 may be mounted in any configuration that provides the desired sound. Sound producing devices 109 may includes features such as a built-in microphone, built-in speakers, subwoofer and/or digital amplifier with multiple independent channels of audio.

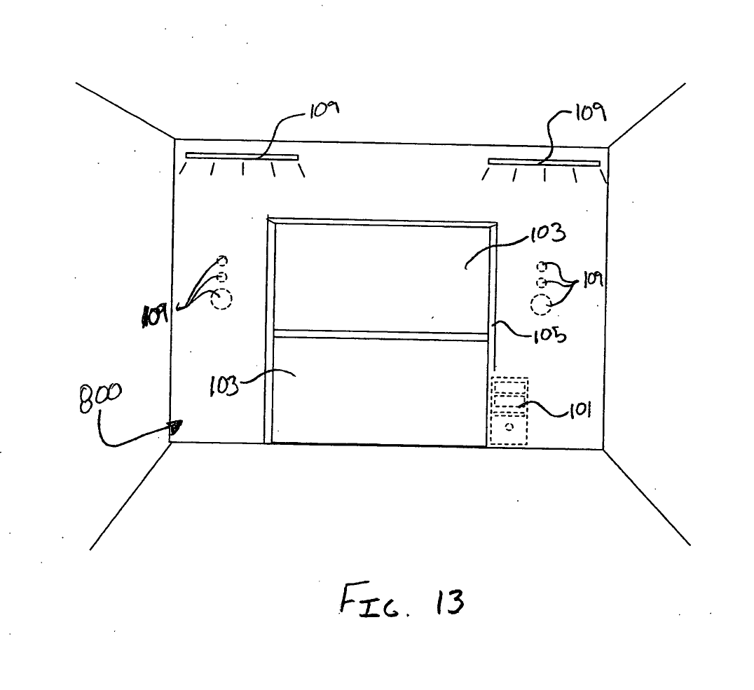

FIG. 13 shows an alternate arrangement for the display device 100 according to another embodiment of the present invention. Like shown and described with respect to FIG. 12, the display device 100 includes lighting devices 107, sound producing devices 109, processing device 101, two display portions 103 and framing 105. The arrangement shown in FIG. 13 provides a larger continuous or semi-continuous display portion 103 providing larger viewing spaces to simulate larger windows or open doorways.

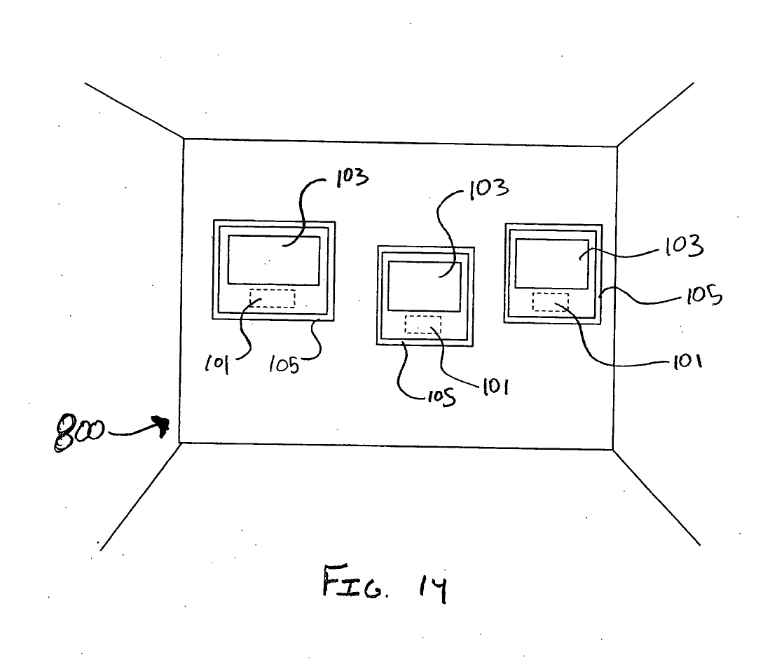

FIG. 14 shows an alternate arrangement for a plurality of independent display devices 100 according to another embodiment of the present invention. The arrangement shown in FIG. 14 may include an arrangement, as would appear in a gallery, lobby or other display location. Each of the shown display devices 100 is independent and is capable of displaying individual motion picture videos. In the embodiment shown in FIG. 14, three display devices 100 are mounted in an aesthetically pleasing arrangement to provide simulated window views of a plurality of independent locations. This embodiment may be utilized to display simulated window views of desired locations or events for information or advertising purposes, which may be used in areas such as travel agencies and/or airports, where views of locations, including real-time viewing of locations may be desirable.

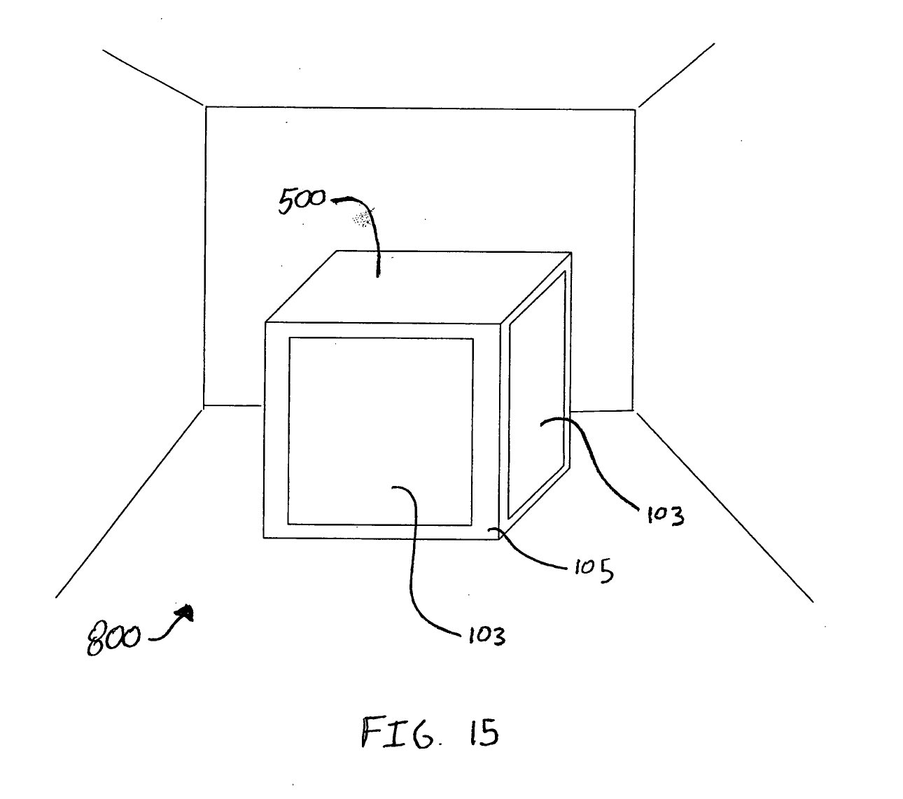

FIG. 15 shows an alternate arrangement for a plurality of independent display devices 100 according to the present invention. In FIG. 15, an article of furniture, such as a file cabinet 500, includes two surfaces, each having a display device 100 that can include a processing device 101 and a pair of display portions 103. As shown in FIG. 15, one display portion 103 can rotate to access the cabinet 500 than can be used a known as a file cabinets known in the art. It is to be understood that other articles of furniture or objects can incorporate the display device 100 of the present invention, and that adjacent display portions 103 can provide a contiguous display. Further it is also to be understood that the display portion 103 is not necessarily planar. That is, the display portion 103 may conform to a curved wall or object.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A display device comprising:
a display portion having a screen for viewing a motion picture video;
a processing device in communication with the display portion and being capable of converting motion picture video data to a motion picture video on the screen, the motion picture video simulating a view as seen from a window, having single point of view, real-time recordings of video locations having continuous motion picture video segments; and
framing attached to the display portion configured to provide the display portion and the framing with the appearance of a window, framed photograph, painting or wall-hanging.

2. The display device of claim 1, wherein the components include a structure selected from the group consisting of a window frame and a picture frame.

3. The display device of claim 1, wherein the motion picture video data includes uninterrupted video segments of at least 5 minutes substantially devoid of time compression.

4. The display device of claim 1, wherein the processing device is integrated into the framing components.

5. The display device of claim 1, further comprising a lighting device in communication with the processing device to produce light of a color and intensity corresponding to the light and intensity of light shown in the motion picture video.

6. The display device of claim 1, further comprising sound producing devices in communication with the processing device to produce sound corresponding to the sound in the motion picture video.

7. The display device of claim 1, further comprising a plurality of display portions in communication with the processing device.

8. A display device system comprising:
a video capture device;
a computing device in communication with the video capture device;
a display device comprising:
a display portion having a screen for viewing a motion picture video;
a processing device in communication with the display portion and being capable of converting motion picture video data captured by the video capture device to a motion picture video on the screen, the motion picture video simulating a view as seen from a window, having single point of view, real-time recordings of video locations having continuous motion picture video segments greater than about 5 minutes in length; and
framing attached to the display portion configured to provide the display portion and the framing with the appearance of a window, framed photograph, painting or wall-hanging.

9. The display device system of claim 8, further comprising a distribution system in communication with the computing device for distributing motion picture video, the distribution system comprising a distribution mechanism selected from the group consisting of physical delivery, digital data network and broadcasting network.

10. The display device system of claim 8, further comprising a data storage system in communication with the computing device for storing the motion picture video data for subsequent transfer of the motion picture video to the display device.

11. The display device of claim 8, wherein the components include a structure selected from the group consisting of a window frame and a picture frame.

12. The display device of claim 8, wherein the motion picture video data includes uninterrupted video segments of at least 5 minutes substantially devoid of time compression.

13. The display device of claim 8, wherein the processing device is integrated into the framing components.

14. The display device of claim 8, further comprising a lighting device in communication with the processing device to produce light of a color and intensity corresponding to the light and intensity of light shown in the motion picture video.

15. The display device of claim 8, further comprising sound producing devices in communication with the processing device to produce sound corresponding to the sound in the motion picture video.

16. The display device of claim 8, further comprising a plurality of display portions in communication with the processing device.

17. A method for visually extending a room space and creating desired controlled emotional experience comprising:
capturing motion picture video data with a video and audio capture device;
processing the motion picture video data to produce a motion picture video;
displaying the motion picture video on a display device comprising:
a display portion having a screen for viewing the motion picture video;
a processing device in communication with the display portion; and
framing attached to the display portion configured to provide the display portion and the framing with the appearance of a window, framed photograph, painting or wall-hanging.
wherein the motion picture video simulates a view as seen from a window, having single point of view, real-time recordings of video locations having continuous motion picture video segments.

18. The method of claim 17, further comprising a plurality of display portions in communication with the processing device.

19. The method of claim 18, wherein the processor independently provides each of the plurality of display portions with the motion picture video.

20. The method of claim 17, further comprising distributing the motion picture video with a distribution system, the distribution system comprising a distribution mechanism selected from the group consisting of physical delivery, digital data network and broadcasting network to the processor.

21. The method of claim 17, further comprising storing the motion picture video with a data storage system for subsequent transfer of the motion picture video to the display device.

22. The method of claim 17, further comprising providing lighting with a lighting device in communication with the processing device to produce light of a color and intensity corresponding to the light and intensity of light shown in the motion picture video.

23. The method of claim 17, further comprising providing sound with a sound producing devices in communication with the processing device to produce sound corresponding to the sound in the motion picture video.
